(19) United States
(12) Patent Application Publication
(10) Pub. No.: US 2008/0231828 A1
(43) Pub. Date: Sep. 25, 2008

(54) Distance Measuring Equipment, and Method of Mounting an Electrooptical Unit on a Lead Frame Unit

(76) Inventors: Uwe Skultety Betz, Leinfelden-Echterdingen (DE); Bjoern Haase, Stuttgart (DE); Joerg Stierle, Waldenbuch (DE); Peter Wolf, Leinfelden-Echterdingen (DE); Cedric Pahud, Morges (CH); Kai Renz, Leinfelden-Echterdingen (DE)

Correspondence Address: MICHAEL J. STRIKER, 103 EAST NECK ROAD, HUNTINGTON, NY, 11743, US

(21) Appl. No.: 11/996,530

(22) PCT Filed: Jun. 26, 2006
(86) PCT No.: PCT/EP2006/063547

§ 371 Date: May 29, 2008

(30) Foreign Application Priority Data
Jul. 28, 2005 (DE) 10 2005 035 417.3

(51) Int. Cl. G01C 3/08

(52) U.S. Cl. 356/4.01

(57) ABSTRACT

The invention is based on a piece of distance measuring equipment, particularly a laser rangefinder (10) in the form of a hand-held appliance, having a lead frame unit (18) and an electrooptical unit (20, 26) which comprises a transmission or reception unit (22, 28) and a lens support unit (24, 30, 62). It is proposed that the lens support unit (24, 30, 62) be supported by the lead frame unit (18).

### PRIOR ART

The invention is based on a distance measuring device, in particular a laser rangefinder embodied in the form of a hand-held unit, as recited in the preamble to claim 1. The invention also relates to a method for mounting an electrooptical unit onto a conductor support unit, as recited in the preamble to claim 10.

EP 1 351 070 A1 has disclosed a distance measuring device equipped with an optics support to which optical elements for shaping a measurement signal are mounted and a printed circuit board that is situated in the optics support. To produce a measurement signal, the distance measuring device is provided with a laser diode that is electrically connected to the printed circuit board.

### ADVANTAGES OF THE INVENTION

With respect to the distance measuring device, the invention is based on a distance measuring device, in particular a laser rangefinder embodied in the form of a hand-held unit, equipped with a conductor support unit and an electrooptical unit that includes a transmitter unit or a receiver unit and an optics support unit.

According to the invention, the optics support unit is supported by the conductor support unit. This makes it possible to achieve a simple design and a compact embodiment of the distance measuring device, which is particularly advantageous in distance measuring devices embodied in the form of hand-held units. If the conductor support unit is embodied in the form of a combined support element for the transmitter or receiver unit and the optics support unit, then it is also possible to achieve a rigid connection between the optics support unit and the transmitter or receiver unit, which is advantageously also mounted onto the conductor support unit, e.g. by means of electrical connections. The optics support unit is advantageously provided for supporting at least one optical component, e.g. a lens, diaphragm, funnel, etc., and can, for example, be embodied in the form of a support sleeve for containing the optical component. The optics support unit is supported by the conductor support unit; the optics support unit can be embodied as separate from the conductor support unit or can be integrally formed onto the conductor support unit, e.g. embodied the form of a recess in the conductor support unit into which an optical component is inserted. In another possible embodiment, the optics support unit can be integrally formed onto an optical component, e.g. embodied as a support element that is formed onto a lens and is supported by the conductor support unit. The electrooptical unit with the transmitter unit and the optics support unit in which an optical component, for example, is preinstalled can be embodied in the form of a collimation unit that is entirely integrated into the conductor support unit.

A high degree of stability of the transmitter or receiver unit can be achieved if the transmitter or receiver unit has a housing that is integrally joined directly to the conductor support unit. This also makes it possible to eliminate additional support elements for the transmitter or receiver unit. An electrical connection between the transmitter or receiver unit and the conductor support unit can be manufactured directly between the housing and an electrical line of the conductor support unit by means of the integral connection, which makes it possible to achieve particularly short paths for an electrical current between the transmitter or receiver unit and the conductor support unit during operation of the distance measuring device. Preferably, a ground line of the transmitter or receiver unit is connected in this way to the ground line of the conductor support unit. Producing an electrical connection via short paths makes it possible to avoid an undesirable electromagnetic emission caused, for example, by the use of high-frequency modulated electrical signals for a distance measurement and their emission through the housing and/or through additional metallic support elements for the transmitter or receiver unit. It is also possible to avoid using shielding means provided to prevent this emission, to reduce occurrences of undesirable interference such as between transmission electronics and reception electronics of the distance measuring device, and to achieve a more effective transmission of electrical signals between the transmitter or receiver unit and the conductor support unit. Furthermore, it is possible to avoid fastening an additional ground connection means of the transmitter or receiver unit, e.g. a connecting pin. The integral connection also makes it possible for a heat that is generated during operation to be dissipated from the transmitter or receiver unit. The integral connection can also be embodied in the form of solder. Alternatively, it is also conceivable for the transmitter or receiver unit to be glued to the conductor support unit.

Preferably, the optics support unit is embodied in the form of a tubular element, thus making it possible to advantageously protect optical components contained in the optics support unit.

A particularly high degree of stability of the optics support unit can be achieved if the optics support unit rests against the conductor support unit with a flat contact surface.

An advantageous protection of the transmitter or receiver unit can be achieved if the transmitter or receiver unit is at least partially encompassed by the optics support unit.

According to another embodiment, a shoulder-shaped light attenuation element is situated in the casing. This makes it possible to reduce an undesired emission through an adjustment gap between the transmitter or receiver unit and the optics support unit, which gap is required for an adjustment of the optics support unit in relation to the transmitter or receiver unit.

Preferably, the optics support unit is manufactured of plastic. This can achieve an advantageous electrical insulation of the optics support unit from the conductor support unit and a resulting reduction in occurrences of electromagnetic interference between transmission electronics and reception electronics of the distance measuring device. It is also possible to compensate for a shift in a focal point of the transmission or reception optics caused by a variation of a refractive index with the temperature due to an expansion of the optics support unit. In addition, the optics support unit can, for example, be embodied as integrally formed onto a plastic lens.

In another embodiment of the invention, the optics support unit is glued to the conductor support unit at a glue point. It is therefore possible to achieve a secure mounting of the optics support unit onto the conductor support unit during an assembly of the distance measuring device, thus making it possible to avoid a transmission of heat and an accompanying possible damage to the optics support unit.

If the conductor support unit is UV radiation-permeable at the glue point, then it is possible to achieve an advantageous non-contact mounting of the optics support unit onto the conductor support unit in that an adhesive applied to the glue point is hardened by a beaming of UV radiation through the conductor support unit. In this context, the term “permeability” is particularly understood to be a permeability of at least 10% and preferably greater than 30%, in particular greater than 50%.

With respect to the method, the invention is based on a method for mounting an electrooptical unit onto a conductor support unit in a manufacture of a distance measuring device in which the electrooptical unit is equipped with a transmitter or receiver unit and an optics support unit.

According to the invention, first the transmitter or receiver unit and then the optics support unit is mounted onto the conductor support unit. The advantage of this method lies in the fact that the transmitter or receiver unit can be mounted in a position that is specifically predetermined to achieve an effective mechanical mounting onto the conductor support unit, to achieve an effective electrical connection to the conductor support unit, and/or to achieve a transmission of a signal with a desired orientation and a desired height in relation to the conductor support unit.

In order to be able to precisely achieve a mounting of the transmitter or receiver unit in such a desired position, the transmitter or receiver unit is advantageously held in a predetermined desired position while the transmitter or receiver unit is being mounted. In addition, when the desired position is being determined before execution of the mounting method, it is possible to take into account potential movements of the transmitter or receiver unit after the attachment process, e.g. stresses or relaxation of stresses that occur during a cooling process after a soldering procedure or during a hardening process.

Advantageously, an adhesive is applied at a glue point and the optics support unit is adjustably positioned on the conductor support unit at the glue point. This makes it possible to flexibly and precisely achieve an optics support unit position that is adjusted in relation to the transmitter or receiver unit, in which position the optics support unit can then be directly mounted.

The optics support unit, which is situated in an adjusted position, can be prevented from undesirably shifting as it is being mounted onto the conductor support unit in that the optics support unit is affixed to the conductor support unit in an adjusted position through a hardening process of the adhesive. Alternatively, other non-contact methods for mounting the optics support unit onto the conductor support unit are conceivable, such as ultrasonic welding or laser welding.

According to another embodiment of the invention, with a fixed transmitter or receiver unit, the optics support unit is adjusted. As a result, optical components premounted in the optics support unit can be simultaneously adjusted through the adjustment of the optics support unit in relation to the transmitter or receiver unit, thus making it possible to eliminate a complex adjustment of individual optical components.

According to another mounting method of the invention, first the optics support unit and then the transmitter or receiver unit is mounted onto the conductor support unit. The adjustment of the optics support unit can be eliminated, thus reducing a manufacturing complexity during an assembly of the distance measuring device.

### DRAWINGS

Other advantages ensue from the following description of the drawings. The drawings show exemplary embodiments of the invention. The drawings, the description, and the claims contain numerous features in combination. Those skilled in the art will also suitably consider these features individually and unite them in other meaningful combinations.

FIG. 1 is a perspective view of a distance measuring device equipped with a conductor support unit and two electrooptical units,

FIG. 2 is a top view of the conductor support unit and one of the electrooptical units from FIG. 1, equipped with a transmitter unit and an optics support unit,

FIG. 3 is a sectional view of the conductor support unit, the transmitter unit, and the optics support unit,

FIG. 4 is a side view of the optics support unit and the conductor support unit,

FIG. 5 is a sectional view of the conductor support unit, the transmitter unit, and an alternative optics support unit equipped with a protrusion, and

FIG. 6 is a sectional view of the protrusion of the optics support unit from FIG. 5, equipped with a light attenuation element.

### DESCRIPTION OF THE EXEMPLARY EMBODIMENTS

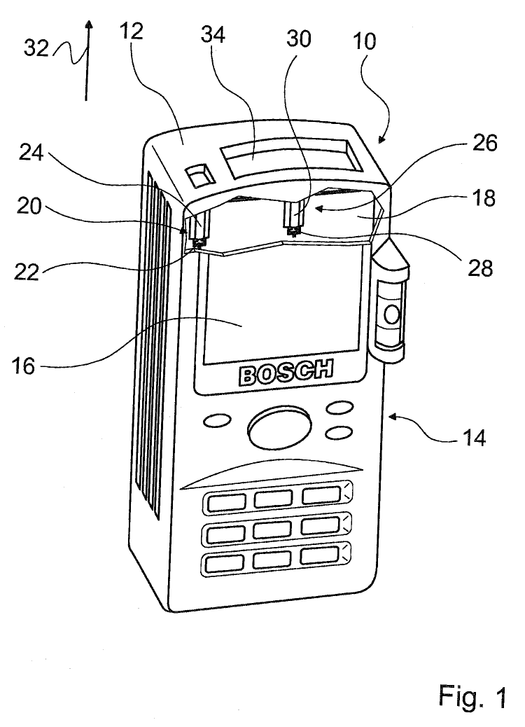

FIG. 1 shows a distance measuring device embodied in the form of a laser rangefinder 10. This laser rangefinder has a housing 12, control elements 14 for switching the distance measuring device on and off and for starting and configuring a measuring procedure, as well as display 16. Inside the housing 12 is contained a conductor support unit 18 embodied in the form of a printed circuit board onto which an electrooptical unit 20 is mounted. This electrooptical unit has a transmitter unit 22 embodied in the form of a laser diode and an optics support unit 24. Also provided on the conductor support unit 18 is an additional electrooptical unit 26, which has a receiver unit 28 embodied in the form of a photodiode and an optics support unit 30. To measure a distance of the laser rangefinder 10 from a remote object, during operation of the laser rangefinder 10, a transmission signal in the form of a laser beam is transmitted by the transmitter unit 22 in a signal direction 32 parallel to the conductor support unit 18 and is collimated by a collimation lens 33 (FIG. 2) situated in the optics support unit 24. The laser beam reflected by a surface of the remote object is received as a reception signal by the receiver unit 28 through a focusing lens 34 and is converted into an electrical signal. The distance being measured is then determined based on a comparison of the transmission signal to the reception signal. In order to control the transmitter unit 22 and receiver unit 28, to process the reception signal, and to evaluate the distance from the remote object, other electronic components not shown here for the sake of clarity, are situated on the conductor support unit 18.

The conductor support unit 18, the transmitter unit 22, and the optics support unit 24 are shown in a detail view in FIG. 2. The transmitter unit 22 embodied in the form of a laser diode has a housing 36 and two electrical connections 38 embodied in the form of pins. For the attachment of the transmitter unit 22, the surface of the conductor support unit 18 is provided with four soldering surfaces 40 that are coated with solder alloys embodied as mounting means 42, 44. The electrical connections 38 are mounted onto the conductor support unit 18 by means of the mounting means 44; the transmitter unit 22 is electrically connected to the conductor support unit 18 via the mounting means 44. The housing 36 is integrally mounted directly to the conductor support unit 18 via the mounting means 42 and is electrically connected to a ground line 46 of the conductor support unit 18 via these mounting means 42. The optics support unit 24, which is mounted onto the conductor support unit 18 in a position that is adjusted in relation to the transmitter unit 22, is embodied as a tubular element that has a tubular base body 50 centered around an optical axis 48 and two wing elements 52 integrally formed onto this base body 50. These wing elements 52, which rest against the conductor support unit 18, support the optics support unit 24 on the conductor support unit 18. In addition, the optics support unit 24 has an extension 54 in which the collimation lens 33 is situated.

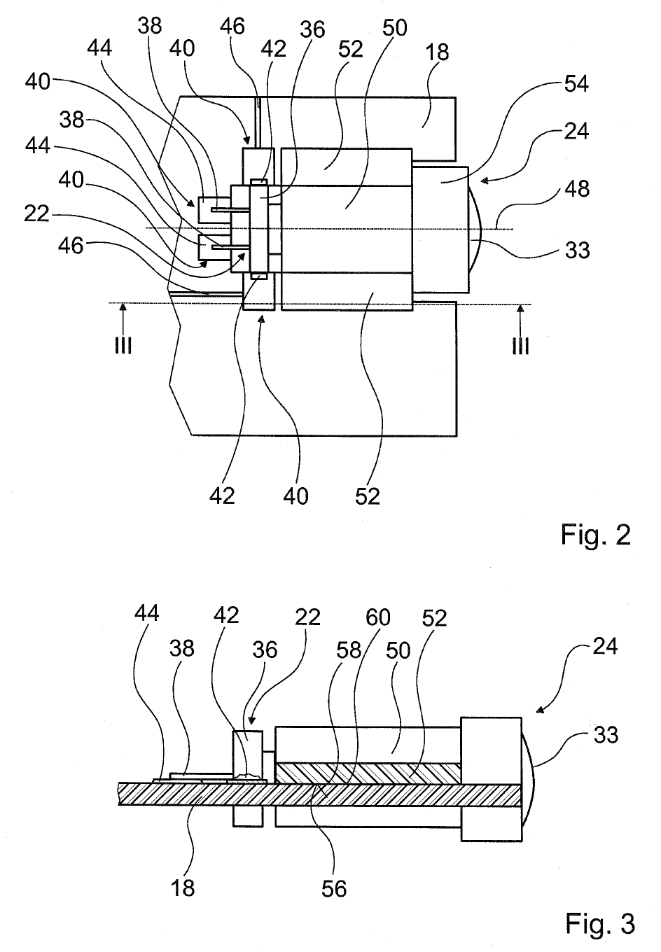

The arrangement of the transmitter unit 22 and the optics support unit 24 on the conductor support unit 18 is depicted in FIG. 3 in a sectional view along the axis III from FIG. 2, parallel to the optical axis 48. The drawing shows the housing 36 and one of the electrical connections 38 of the transmitter unit 22 that are mounted onto the conductor support unit 18 via the mounting means 42 and 44. The wing elements 52 of the optics support unit 28 rest with an essentially flat contact surface 56 against the conductor support unit 18 and are glued to the conductor support unit 18 by means of an adhesive 60 at two glue points 58 on both sides of the base body 50. On the side of the contact surface 56, the wing elements 52 can also have additional recesses or receptacles such as one or more channels, into which excess adhesive can be displaced in order to assure that the wing elements 52 rest flat against the conductor support unit 18. Alternatively, such recesses could also be provided in the conductor support unit 18.

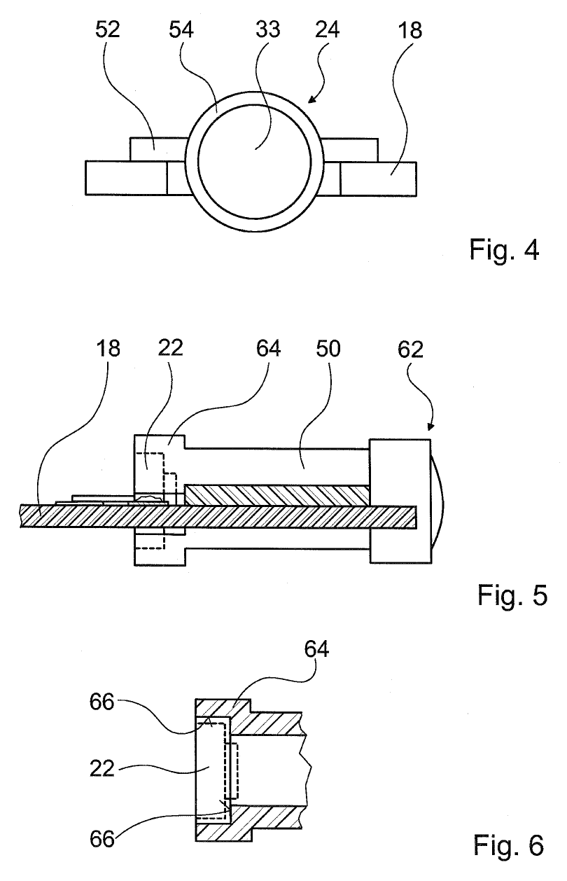

FIG. 4 shows the arrangement of the optics support unit 24 on the conductor support unit 18 radial to the optical axis 48. The drawing shows the extension 54 in which the collimation lens 33 is situated and the wing elements 52 that rest against the conductor support unit 18, thus supporting the optics support unit 24.

In the same sectional view as FIG. 2, FIG. 5 shows the conductor support unit 18, the transmitter unit 22, and an alternative optics support unit 62. In this embodiment, this optics support unit also has a protrusion 64 that is formed onto the base body 50 and partially encompasses the transmitter unit 22.

FIG. 6 shows a sectional view of the protrusion 64 of the optics support unit 62. An inner surface of protrusion 64 oriented toward the transmitter unit 22 is shaped in accordance with the outer contour of the transmitter unit 22 and is embodied in the form of a shoulder-shaped light attenuation element 66. In order to attenuate a laser beam being beamed through the interior of the base body 50, the inner surface is provided with a light-absorbing means.

In the exemplary embodiments considered above, the receiver unit 28 and the optics support unit 30 of the additional electrooptical unit 26 are constructed and mounted onto the conductor support unit 18 in the same way as has been described in conjunction with FIGS. 2 through 6 for the electrooptical unit 20. Therefore, this description will not be repeated for the additional electrooptical unit 26 and corresponding parts of the receiver unit 28 and optics support unit 30 will not be provided with new reference numerals.

In a manufacture of the laser rangefinder 10, the electrooptical unit 20 is mounted onto the conductor support unit 18. The transmitter unit 22 of the electrooptical unit 20 and the housing 36 here are first moved into a predetermined desired position by means of an auxiliary tool. To accomplish this, an actual position of the transmitter unit 22, in particular a height of the transmitter unit 22 in relation to the conductor support unit 18, is detected with the aid of an optical measurement. The transmitter unit 22 is moved until its actual position coincides with a predetermined desired position in which the transmitter unit 22 is positioned in FIGS. 2, 3, and 5. The housing 36 and the electrical connections 38 are soldered to the soldering surfaces 40, with the auxiliary tool additionally holding the transmitter unit 22 in the desired position that has been achieved. Then the adhesive 60 is applied to the glue points 58 on the conductor support unit 18 and the optics support unit 24 is adjustably positioned on the conductor support unit 18 at the glue points 58. The transmitter unit 22 is switched on, producing a laser beam whose orientation toward the conductor support unit 18 and whose divergence are measured by measuring devices. Based on the measurement data obtained, the optics support unit 24 is adjusted in relation to the transmitter unit 22 until these data coincide with predetermined desired values and/or until the laser beam has a desired orientation in relation to the conductor support unit 18 and a desired form. Then, the optics support unit 24 is mounted onto the conductor support unit 18 in an adjusted position in which the optics support unit 24 is positioned in FIGS. 2 and 3, namely in that the adhesive 60 is hardened by beaming UV radiation through the conductor support unit 18, which is embodied as UV radiation-permeable at the glue points 58.

According to another mounting method of the electrooptical unit 20, first the optics support unit 24 is glued to the conductor support unit 18 in a predetermined desired position, then the transmitter unit 22 is adjusted in relation to optics support unit 24 and soldered to the conductor support unit 18 in an adjusted position. The optics support unit 62 is mounted onto the conductor support unit 18 in the manner described for the optics support unit 24. In addition, the electrooptical unit 26 is preferably mounted onto the conductor support unit 18 with the aid of one of the mounting methods described above for the electrooptical unit 20.

What is claimed is:

1. A distance measuring device, in particular a laser rangefinder (10) embodied in the form of a hand-held unit, equipped with a conductor support unit (18) and an electrooptical unit (20, 26) that includes a transmitter or receiver unit (22, 28) and an optics support unit (24, 30, 62),
wherein the optics support unit (24, 30, 62) is supported by the conductor support unit (18).

2. The distance measuring device as recited in claim 1,
wherein the transmitter or receiver unit (22, 28) has a housing (36) that is integrally mounted directly onto the conductor support unit (18).

3. The distance measuring device as recited in claim 1,
wherein the optics support unit (24, 30, 62) is embodied in the form of a tubular element.

4. The distance measuring device as recited in claim 1,
wherein the optics support unit (24, 30, 62) rests with an essentially flat contact surface (56) against the conductor support unit (18).

5. The distance measuring device as recited in claim 1,
wherein the transmitter or receiver unit (22, 28) is at least partially encompassed by the optics support unit (62).

6. The distance measuring device as recited in claim 5,
wherein a shoulder-shaped light attenuation element (66) is situated in the casing.

7. The distance measuring device as recited in claim 1,
wherein the optics support unit (24, 30, 62) is manufactured out of plastic.

8. The distance measuring device as recited in claim 1,
wherein the optics support unit (24, 30, 62) is glued to the conductor support unit (18) in at least one glue point (58).

9. The distance measuring device as recited in claim 8,
wherein the conductor support unit (18) is UV radiation-permeable at the glue point (58).

10. A method for mounting an electrooptical unit (20, 26) onto a conductor support unit (18) during a manufacture of a distance measuring device in which the electrooptical unit (20, 26) has a transmitter or receiver unit (22, 28) and an optics support unit (24, 30, 62),
wherein first the transmitter or receiver unit (22, 28) and then the optics support unit (24, 30, 62) is mounted onto the conductor support unit (18).

11. The method as recited in claim 10,
wherein during the mounting of the transmitter or receiver unit (22, 28), the transmitter or receiver unit (22, 28) is held in a predetermined desired position.

12. The method as recited in claim 10,
wherein an adhesive (60) is applied to a glue point (58) and the optics support unit (24, 30, 62) is adjustably positioned on the conductor support unit (18) at the glue point (58).

13. The method as recited in claim 12,
wherein the optics support unit (24, 30, 62) is affixed to the conductor support unit (18) in an adjusted position by a hardening of the adhesive (60).

14. The method as recited in claim 10,
wherein with a fixed transmitter or receiver unit (22, 28), the optics support unit (24, 30, 62) is adjusted.

15. The method as recited in claim 10,
wherein first the optics support unit (24, 30, 62) and then the transmitter or receiver unit (22, 28) is mounted onto the conductor support unit (18).
